(19) United States
(12) Patent Application Publication
(10) Pub. No.: US 2011/0307155 A1
(43) Pub. Date: Dec. 15, 2011

(54) METHOD AND SYSTEM FOR LIMITING A DYNAMIC PARAMETER OF A VEHICLE

(76) Inventor: Christian Simard, Terrebone (CA)

(21) Appl. No.: 13/203,219

(22) PCT Filed: Feb. 24, 2010
(86) PCT No.: PCT/CA10/00262

§ 371 Date: Aug. 24, 2011

Related U.S. Application Data
(60) Provisional application No. 61/154,998, filed on Feb. 24, 2009.
(60) Provisional application No. 61/266,738, filed on Jan. 19, 2010.
(60) Provisional application No. 61/307,217, filed on Feb. 23, 2010.

(51) Int. Cl. F02D 41/10; F02D 41/14; F02D 28/00

(52) U.S. Cl. 701/93; 701/102

(57) ABSTRACT

The present invention relates to a method for limiting a dynamic parameter of a vehicle, such as speed or acceleration, and to a vehicle dynamics control module (VDCM), an engine control module (ECM) and a system for carrying out the method as well as to a computer product associated thereto. The present invention allows a driver of a vehicle to be provided with an acceptable acceleration, speed and/or the like, which may be lower than the requested acceleration, speed, etc., in order to optimize energy consumption of the vehicle, typically for transportation vehicles such as trucks, buses and delivery vans. This is accomplished, by a continuously running controller, such as a PI controller and by limiting the integral term of the PI controller, to smoothen transitions when the dynamic parameter is limited and to substantially reduce overshoot with respect to the limit of the dynamic parameter.

### FIELD OF THE INVENTION

The present invention relates to the field of vehicle dynamics control. More particularly, the present invention relates to a method for limiting a dynamic parameter of a vehicle, as well as to a vehicle dynamics control module (VDCM), to an engine control module (ECM) and to a system for carrying out the method, as well as to a computer product associated thereto.

### BACKGROUND OF THE INVENTION

It is well known in the art that most transportation vehicles, such as trucks, buses and delivery vans, run on high powered engines. Such vehicles, loaded at maximum capacity, must be enabled to climb a hill. However, when transporting a relatively small load, the extra engine power is generally used by the driver to accelerate rapidly between stops, resulting in excessive fuel consumption and most often excessive wear of the engine and other drive train components. Thus there is a need for an improved engine control system.

Known to the Applicant are U.S. Pat. No. 7,121,977 issued to MARKYVECH on Oct. 17, 2006, No. 4,566,414 issued to SIEBER on Jan. 28, 1986 and No. 5,775,290 issued to STAERZL et al. on Jul. 7, 1998, as well as US patent application No. 2007/0251493 in the name of EVANS, published on Nov. 1, 2007. However, the teachings of the aforementioned documents suffer from drawbacks, as will be apparent in view of the following explanations.

Engine control systems on conventional modern vehicles use an electronic accelerator pedal transducer for receiving an input signal corresponding to the driver's desired vehicle speed or acceleration, based on the position of the pedal, and for generating a corresponding output signal to be sent to an electronic throttle control (ETC) and/or other engine actuators. During the acceleration of the vehicle, the driver presses on the accelerator pedal at a certain degree for adjusting the vehicle acceleration as desired and when the targeted speed is attained, the driver generally releases the accelerator pedal to a degree at which the acceleration is nil and the speed is thus constant. An engine control modules typically executes a complex algorithm for processing the accelerator pedal signal and controlling the engine power, the algorithm applying a complex interpretation method which may vary from one vehicle to another (depending on signals received, steps of the method, different adjustments, etc.). For example, it may relate to a degree of opening of the throttle valve or alternatively, it may also relate to a target engine speed or target engine torque. However, regardless of the interpretation of the signal by the engine control module, when the driver presses the accelerator pedal at a maximum degree (full throttle), the engine is expected to provide a maximum torque at any engine speed. This engine torque generates a force producing an acceleration which varies depending on the mass of the vehicle according to the following equation (Newton's Second Law of Motion):

F=m×a,

wherein F represents the forward force, that is, the engine torque multiplied by a drive train ratio and, subtracted thereto, an internal friction and external brake force (wind, tire deformation, etc.), m representing the mass of the vehicle and a representing the acceleration of the vehicle. The acceleration for any engine torque, is inversely proportional to the mass of the vehicle.

It is generally believed that a higher acceleration and speed will lead one more quickly from a point A to a point B and that this will compensate for a higher rate of fuel consumption. However, the equation which relates acceleration to distance is not linear. Indeed, the following second degree equation applies:

distance=½×acceleration×time².

Therefore, as a simplified example, for travelling across a distance of one kilometre at a constant acceleration rate of 1 m/s², the time required is 44.72 seconds. If the acceleration is doubled, that is 2 m/s², the time required to travel a distance of one kilometre is 31.62 seconds. Thus, doubling the acceleration requires double the energy. However, it does not reduce the time required in half. Indeed, the net energy used to travel across the distance of one kilometre at double the acceleration requires 41% more energy.

Furthermore, not every vehicle has the same efficiency and, moreover, a particular engine does not have the same efficiency at every speed-torque combination. Indeed, a conventional engine generally tends to be more efficient at a higher output, given the fact that the theoretical engine efficiency depends mainly on, among other parameters, the difference between highest and lowest temperatures in the combustion chamber. Therefore, a lower acceleration does not necessarily imply lower fuel consumption.

Thus, it is very unlikely that any good driver can control a vehicle having variable engine torque, speed and/or efficiency and a variable mass of the vehicle in such a fashion that he or she can minimize the fuel consumption to an optimal level.

Also known to the Applicant is U.S. Pat. No. 6,167,343 issued to BAUERLE on Dec. 26, 2000. BAUERLE teaches an improved method of vehicle acceleration governing in an electronic throttle control (ETC) system of a vehicle wherein an acceleration governing function is typically requested under certain failure mode conditions, and operates under such conditions to limit the vehicle acceleration to a threshold value, which may be determined based on vehicle speed.

The method is carried out by a PI controller (Proportional-Integral controller). A PI controller is operated by a generic control loop feedback mechanism and attempts to correct the error between a measured process variable and a desired setpoint by calculating and then outputting a corrective action that can adjust the process accordingly and rapidly, to keep the error minimal.

The PI controller operation algorithm involves two “closed-loop” parameters, namely a proportional term (P) and an integral term (I), whose sum determine a controller output (u(t)) at an instantaneous time (t), according to the following equation:

u(t)=P+I=(K_{P}×e(t))+(K_{I}×∫₀^{t}e(τ)×dτ).

The proportional term P determines the reaction to the current error, and the integral term I determines the reaction based on the sum of recent errors. The weighted sum u(t) of these two actions is used to adjust the process via a control element, such as a throttle area signal to be used for controlling the engine.

The system taught by BAUERLE introduces an “open-loop” term, dependant on vehicle speed, which is used, together with the closed-loop terms to update a desired throttle area. However, the system of BAUERLE is designed to operate under two modes, namely a default mode wherein the vehicle runs normally without limiting the acceleration, and an acceleration governing mode wherein the acceleration limiting function is engaged. The system of BAUERLE is not suitable for shifting with ease between the two operating modes, and thus could not be used on an on-going basis to control the acceleration of the vehicle. Indeed, if the system of BAUERLE is used permanently to limit the acceleration of the vehicle, the transitions between the governing mode and the non-governing mode are very likely to be apparent to the driver and to cause discomfort. Moreover, such transitions may be perceived as a defect in the vehicle

Furthermore, the system of BAUERLE uses empirical values provided, for example in a table, to determine the open-loop term, the empirical values being closely linked to the type of vehicle and to the nominal weight of the vehicle. The system of BAUERLE is thus intended as an original equipment manufacturer (OEM) product. Indeed, the system is made integral with the vehicle ECM and it would be impossible or at the very least difficult to add the BAUERLE system to an existing vehicle.

Moreover, the control algorithm of the acceleration governing mode of BAUERLE is relatively inflexible.

Hence, in light of the aforementioned, there is a need for an improved system which, by virtue of its design and components, would be able to overcome some of the above-discussed prior art concerns.

### SUMMARY OF THE INVENTION

The object of the present invention is to provide a device which, by virtue of its design and components, satisfies some of the above-mentioned needs and is thus an improvement over other related engine control systems and/or methods known in the prior art.

In accordance with an aspect of the present invention, the above mentioned object is achieved, as will be easily understood, by a vehicle control module, system and/or method, such as the one briefly described herein and such as the one exemplified in the accompanying drawings.

According to an aspect of the present invention, there is provided a method for limiting a dynamic parameter of a vehicle, via an engine controller of said vehicle, the engine controller being operable in response to a control signal. The method comprises:
a) receiving vehicle data from the vehicle, said vehicle data being at least representative of a requested engine power;
b) determining, based on said vehicle data, a command signal associated to the requested engine power;
c) determining, based on a computation of the vehicle data, a cumulative-term limit;
d) determining a cumulative closed-loop term, based on a computation of the vehicle data, the cumulative closed-loop term being limited according to the cumulative-term limit;
e) determining a control-signal limit, based on at least the cumulative closed-loop term, the control-signal limit being associated to an engine-power-request limit; and
f) generating the control signal to be sent to the engine controller, based on at least a comparison of the command signal and the control-signal limit, the control signal being representative of a lesser of the requested engine power and the engine-power-request limit, for limiting said dynamic parameter of the vehicle.

Preferably, the method is provided by a continuously running PI controller, using an integral closed-loop term (i.e. cumulative closed-loop term) and a proportional closed-loop term, and further including an integral term upper limit (i.e. cumulative-term limit) which is obtained as a function of the throttle area and/or accelerator pedal position and, optionally, on the speed of the vehicle.

Thus, preferably, the cumulative closed-loop term is an integral closed-loop term INT and the cumulative-term limit is an integral term upper-limit INTLimUp.

Still preferably, the control-signal limit is based on a sum of the integral closed-loop term INT and a proportional closed-loop term PROP.

Preferably, the determining of the cumulative-term limit or the integral term upper-limit INTLimUp is based on at least one of: said command signal, a speed of the vehicle and said control signal.

The method, according to embodiments of the present invention, reduces the need for detecting when to activate a limiting mode of operation and also the need for using empirical values. The method further provides a smoother transition between limiting and non-limiting cycles of the system, which may be virtually undetectable by a driver. Moreover, embodiments of the present invention are applicable with all types of vehicles with little or no adjustment.

According to another aspect of the present invention, there is provided a vehicle dynamics control module (VDCM) for limiting a dynamic parameter of a vehicle, via an engine controller of said vehicle, the engine controller being operable in response to a control signal. The VDCM comprises:
at least one input port for receiving vehicle data from the vehicle, said vehicle data being at least representative of a requested engine power;
a module controller being operatively connected to the at least one input port, for:
   determining, based on said vehicle data, a command signal associated to the requested engine power;
   determining, based on a computation of the vehicle data, a cumulative-term limit;
   determining a cumulative closed-loop term, based on a computation of the vehicle data, the cumulative closed-loop term being limited according to the cumulative-term limit;
   determining a control-signal limit, based on at least the cumulative closed-loop term, the control-signal limit being associated to an engine-power-request limit; and
   generating the control signal to be sent to the engine controller, based on at least a comparison of the command signal and the control-signal limit, the control signal being representative of a lesser of the requested engine power and the engine-power-request limit; and
at least one output port being operatively connected to the module controller, at least one of the at least one output port being in communication with the engine controller for sending thereto the control signal generated by the module controller, to limit said dynamic parameter of the vehicle.

Preferably, and as will be explained in greater detail herein below, the VDCM is enabled to be connected between an accelerator pedal transducer and an engine control module of a vehicle and comprises a circuit for intercepting an actual pedal signal transmitted by the accelerator pedal transducer, receiving the vehicle data and transmitting a corrected pedal signal to the engine control module (ECM) and further comprises a microprocessor operatively connected to the circuit for receiving the actual pedal signal and the vehicle data, for calculating a corrected pedal signal based on an analysis of the vehicle data and the actual pedal signal and for outputting the corrected pedal signal via the circuit to the engine control module, so as to transmit an optimized pedal signal to the engine control module of the vehicle.

According to another aspect of the present invention, there is provided an ECM for limiting a dynamic parameter of a vehicle, via an engine controller of said vehicle, the engine controller being operable in response to a control signal, the ECM comprising data and instructions to:
receive vehicle data from the vehicle, said vehicle data being at least representative of a requested engine power;
determine, based on said vehicle data, a command signal associated to the requested engine power;
determine, based on a computation of the vehicle data, a cumulative-term limit;
determine a cumulative closed-loop term, based on a computation of the vehicle data, the cumulative closed-loop term being limited according to the cumulative-term limit;
determine a control-signal limit, based on at least the cumulative closed-loop term, the control-signal limit being associated to an engine-power-request limit; and
generate the control signal to be sent to the engine controller, based on at least a comparison of the command signal and the control-signal limit, the control signal being representative of a lesser of the requested engine power and the engine-power-request limit, for limiting said dynamic parameter of the vehicle.

According to yet another aspect of the present invention, there is provided a system for limiting a dynamic parameter of a vehicle, the system comprising:
at least one sensing element for generating vehicle data;
a VDCM as described herein, the VDCM being operatively connected to the at least one sensing element for receiving the vehicle data; and
an ECM being operatively connected to the VDCM for receiving the control signal therefrom, to limit said dynamic parameter of the vehicle.

According to yet another aspect of the present invention, there is provided a system for limiting a dynamic parameter of a vehicle, the system comprising:
at least one sensing element for generating vehicle data;
an ECM as described herein, the ECM being operatively connected to the at least one sensing element for receiving the vehicle data; and
one or more engine actuator being operatively connected to the ECM for receiving the control signal therefrom, to limit said dynamic parameter of the vehicle.

According to yet another aspect of the present invention, there is provided a vehicle having a VDCM, an ECM and/or a system, as described herein, enabled to perform the method described herein, in order to limit the dynamic parameter of the vehicle.

According to yet another aspect of the present invention, there is provided a computer product comprising data and instructions to limit a dynamic parameter of a vehicle via an engine controller being operable in response to a control signal, for execution by a CPU to:
receive vehicle data from a vehicle, said vehicle data being at least representative of a requested engine power;
determine, based on said vehicle data, a command signal associated to the requested engine power;
determine, based on a computation of the vehicle data, a cumulative-term limit;
determine a cumulative closed-loop term, based on a computation of the vehicle data, the cumulative closed-loop term being limited according to the cumulative-term limit;
determine a control-signal limit, based on at least the cumulative closed-loop term, a control-signal limit being associated to an engine-power-request limit; and
generate the control signal to be sent to the engine controller, based on at least a comparison of the command signal and the control-signal limit, the control signal being representative of a lesser of the requested engine power and the engine-power-request limit, for limiting said dynamic parameter of the vehicle.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a schematic view of a system for limiting a dynamic parameter of a vehicle, according to an embodiment of the present invention.

FIG. 2 is a flow chart showing a method, according to an embodiment of the present invention.

FIG. 3 is a flow chart representing steps of the method, according to an embodiment of the present invention.

FIG. 4A is a partial flow chart representing a step of the method shown in FIG. 3, according an embodiment of the present invention.

FIG. 4B is a partial flow chart representing a step of the method shown in FIG. 3, according to another embodiment of the present invention.

FIG. 4C is a partial flow chart representing steps of the method shown in FIG. 3, according to another embodiment of the present invention.

FIG. 5 is a flow chart representing steps of the method, according to an embodiment of the present invention.

FIG. 6 is a partial flow chart representing steps of the method, according the embodiment shown in FIG. 5.

FIG. 7 is a flow chart representing steps of the method, according to another embodiment of the present invention.

FIG. 8 is a partial flow chart representing steps of the method, according the embodiment shown in FIG. 7.

FIG. 9 is a schematic view of a system for limiting a dynamic parameter of a vehicle, according to another embodiment of the present invention.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, the expressions “vehicle dynamics control module”, “vehicle acceleration control module”, “acceleration control module” and any other equivalent expression and/or compound words thereof known in the art will be used interchangeably. Furthermore, and also in the context of the present description, the expressions “actual signal”, “electronic signal” or “signal” may also be used interchangeably when referring to “accelerator pedal transducer signal”. The expression “sub-routine” and “module” may also be used interchangeably. The same applies for “motor” and “engine”.

In addition, although the preferred embodiment of the present invention as illustrated in the accompanying drawings comprises components such as an accelerator pedal, an engine control module, a vehicle speed sensor, an engine speed sensor, a circuit, a microprocessor, a memory, etc., as well as elements such as “sub-routine”, “module”, etc., and although the associated method include steps as explained and illustrated herein, not all of these components, configurations and steps are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable configurations, organizations and/or architectures may be used for the vehicle acceleration control module according to the present invention, as will be briefly explained herein and as can be easily inferred herefrom, by a person skilled in the art, without departing from the scope of the invention. Moreover, the order of the steps provided herein should not be taken as to limit the scope of the invention, as the sequence of the steps may vary in a number of ways, without affecting the scope or working of the invention, as can also be understood.

Broadly described, the method of the present invention, as exemplified in the accompanying drawing, limits a dynamic parameter of a vehicle, such as a speed, an acceleration and/or the like. For example, in the case of an acceleration limiting system, the method allows a driver of a vehicle to be provided with an acceptable acceleration, which may be lower than the acceleration requested by the accelerator pedal action, so as to optimize energy consumption of the vehicle, typically for transportation vehicles such as trucks, buses and delivery vans. This is accomplished, according to an embodiment of the present invention, by intercepting the signal transmitted from the existing accelerator pedal transducer and sending a corrected signal to control the engine. The corrected signal is calculated based on a variety of input data and other parameters. The method may be implemented within an existing engine control module (ECM) of a vehicle or it may be provided as an additional component, referred to herein as a vehicle dynamics control module (VDCM).

### Vehicle Acceleration Control Module (VACM)

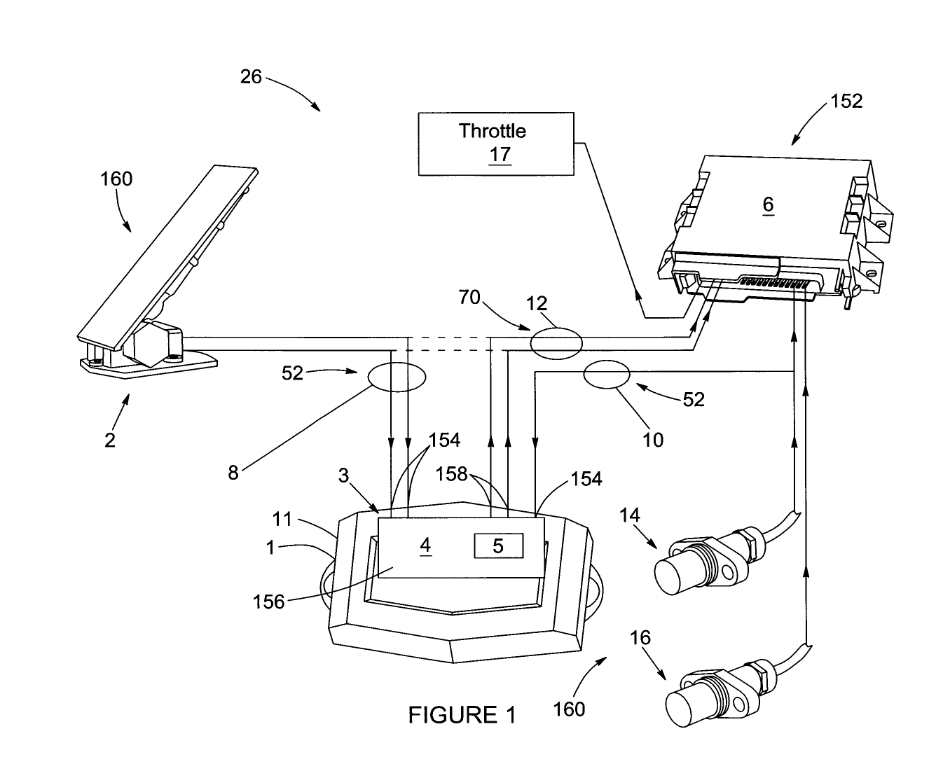

Referring to FIG. 1, a VDCM 11, for limiting the acceleration of a vehicle may be provided by a vehicle acceleration control module (VACM) 1. The VACM 1 intercepts the signal 8 transmitted from the existing accelerator pedal transducer 2 and sends a corrected signal 12 (also referred to herein as “limited signal”, “limited control-signal” or “control signal” 70) to an existing engine control module (ECM) 6 of the vehicle, regardless of the configuration and/or method used by the ECM 6, to control the engine output, for example, to an electronic throttle control (ETC) 17 which controls the throttle of the engine. The corrected signal is calculated based on a variety of input data and other parameters. It is to be understood that the ECM 6 typically manages a number of engine actuators, such as the ETC 17, and may thus send corresponding output signal(s) to each of the actuators.

Preferably, the VACM 1 is connected between an accelerator pedal transducer 2 and an engine control module 6 of a vehicle. The VACM 1 comprises a circuit 3 for intercepting an actual pedal signal 8 transmitted by the accelerator pedal transducer 2, receiving additional vehicle data 10 and transmitting a corrected pedal signal 12 to the engine control module 6, and further comprises a microprocessor 4 operatively connected to the circuit 3 for receiving the actual pedal signal 8 and the additional vehicle data 10, for calculating a corrected pedal signal 12 based on an analysis of the vehicle data 52 received, namely the data 10 and the actual pedal signal 8, and for outputting the corrected pedal signal 12 via the circuit 3 to the ECM 6, so as to transmit an optimized pedal signal 12 to the ECM 6 of the vehicle, as can be easily understood by a person skilled in the art when referring to the accompanying drawings. An output of the ECM 6 is typically connected to the ETC 17 which commands the engine throttle, as previously mentioned.

Preferably, the VACM 1 comprises multiple analog or digital inputs and outputs. The VACM 1 may comprise a first input 8 from the accelerator pedal transducer 2, a second input for receiving data 10 and an output 12 for sending the corrected output signal 12 to the ECM, as can be understood when referring to the drawings. The data 10 is preferably received in the form of one or more electronic signal(s), typically via a Control Area Network (CAN) databus (also referred to herein as “CAN-bus”). Alternatively, the data 10 may be provided directly by one or more sensor, detector, transducer, or the like, such as a vehicle speed sensor 14 or an engine speed sensor 16, as illustrated in FIG. 1, and/or any other sensor or actuator such as an acceleration sensor, an engine position sensor, a wheel position sensor, a position sensor, a geographic location module such as a global positioning system (GPS) receiver, a fuel injector, etc., and/or the like. The data 10 may be received in any suitable data medium, as can be easily understood by a person skilled in the art. Indeed, any of the inputs and outputs, may be signals received and/or transmitted in any suitable format, such as via hard wire, any form of wireless signal, and/or the like.

The microcontroller 4 preferably receives one analog 0-5V input 8 for reading the accelerator pedal position, one analog 0-5V output 12 to provide the vehicle engine control module 1 with an optimized accelerator pedal position value, and a high speed CAN transceiver providing a databus interface or a high speed digital input (10) from a vehicle speed sensor 14. Other inputs and outputs may be included to accommodate different vehicles, for example, for vehicles having an accelerator pedal with two or more transducers to increase security in case of failure of one of the transducers or for other vehicles comprising one or more 0-2.5V signal(s). The VACM 1 according to a preferred embodiment of the present invention, may be adapted to receive other input and/or output signal(s) for receiving or transmitting other signal(s) generated by corresponding sensing elements (example: for future vehicles) and/or components of an existing vehicle engine management system or for connecting to a network of the vehicle, such as a CAN network. Such other signal(s), value(s) and/or information provided, for example, by an engine speed sensor 16, may be used by the VACM 1 to further analyze the efficiency of the engine and/or transmission with regard to the acceleration of the vehicle and provide the engine control module 6 with a signal 12 which may be further optimized.

### Method

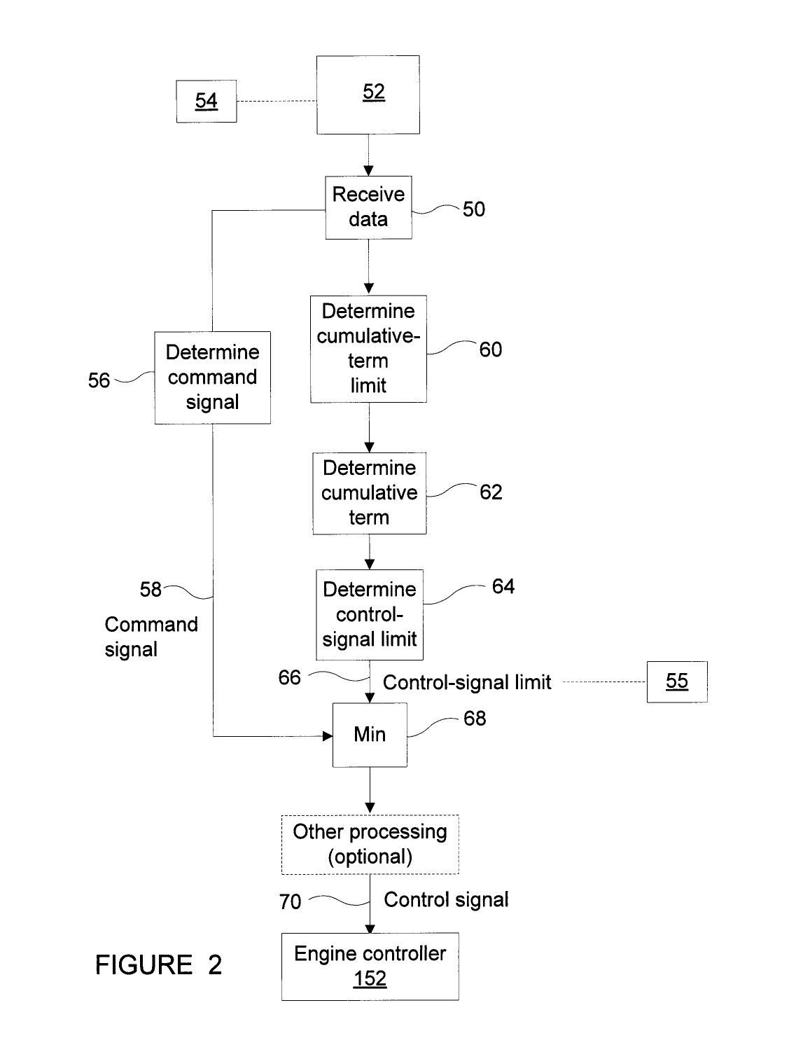

According to a preferred embodiment of the present invention, and as better illustrated in FIG. 2, the above described VDCM 11 or VACM 1 operates according to a method for limiting a dynamic parameter of a vehicle, via an engine controller of the vehicle, the engine controller being operable in response to a control signal 70. The method includes receiving 50 vehicle data 52 from the vehicle, said vehicle data 52 being at least representative of a requested engine power 54; determining 56, based on said vehicle data 52, a command signal 58 associated to the requested engine power 54; determining 60 a cumulative-term limit, based on a computation of the vehicle data 52; determining 62 a cumulative closed-loop term, based on a computation of the vehicle data 52, the cumulative closed-loop term being limited according to the cumulative-term limit; determining 64 a control-signal limit 66, based on at least the cumulative closed-loop term, the control-signal limit 66 being associated to an engine-power-request limit 55; and generating 68 the control signal 70 to be sent to the engine controller 152, based on at least a comparison of the command signal 58 and the control-signal limit 66, the control signal 70 being representative of a lesser of the requested engine power 54 and the engine-power-request limit 55, for limiting said dynamic parameter of the vehicle.

Preferably, the method is reiterated continuously, while the vehicle is running, thus providing a smoother transition when the requested engine power is limited and further reducing overshoot beyond the targeted dynamic parameter. It is to be understood however that not all the steps are required to be executed in the sequence provided hereinabove.

The term “vehicle” is meant to refer not only to motor transportation means such as a car, a truck, a van, a motorcycle, a scooter, a water vehicle, an airplane, a tractor and other farm or utility vehicles, a lawnmower, an electric bicycle, etc. and the like, but also any object, device or structure being movable by an engine or motor, including various toys, such as remote control toy cars, planes, helicopters, etc. and other vehicles used for entertainment or amusement purposes, which may require the limiting of a dynamic parameter, such as speed and acceleration, for reasons related to safety, economy, etc.

It is to be understood that a dynamic parameter may be a speed, an acceleration, a wheel slip (for traction control), an engine speed and/or the like. Thus the above described method may be used for limiting the acceleration of a vehicle, according to embodiments thereof, as exemplified herein. Alternatively, the method may be applied for limiting the speed of a vehicle, or other dynamic parameters of the vehicle. For the purpose of exemplification, the limiting of acceleration and the limiting of speed will be explained with more details herein below.

Moreover, the term “engine controller” refers to any device which controls an engine or motor, either directly or indirectly in response to the control signal 70. An engine controller may be an engine manager, such as, for example, an ECM. In some embodiments, the engine controller may represent an engine actuator, such as, for example, an ETC. The engine controller, may take the form of any device, or group thereof, involved in operating the engine or motor. The engine or motor may be fuel source, compressed air, electrical and/or the like. The engine controller may be an external component with respect to the engine and/or in proximity thereto, or even essentially provided with the engine as part of a motor assembly. Moreover, it is to be understood that the vehicle may include more than one engine, for example a hybrid vehicle, wherein each motor may be either fuel source, compressed air, electrical, etc. and may be controlled by one or more corresponding engine controller (ECM, motor actuator, etc.) Moreover, the term “control signal” may include one or more signal, generated in any suitable format or medium, to be sent to one or more “engine controller”.

Vehicle data may include any information of data, provided in or to the vehicle, as well as any data processed or computed by the vehicle, including the method, the ECM, the VDCM or any of the systems described herein. Vehicle data may include a speed of the vehicle, either current or at a prior time, an acceleration of the vehicle, a geographical position of the vehicle, an accelerator-pedal position, the above-mentioned command signal, the above-mentioned control signal, signals from various sensors, detectors and transducers, information or data received externally (ex: positioning data via satellite), data received as input from a user of the vehicle, and/or the like. Vehicle data may be received in the form of an electronic signal, analog or digital, via a circuit means or wirelessly, as can be understood by a person skilled in the art, and may include any data, information and/or signal received by the vehicle or processed therein. At the very least, the vehicle data includes data and information necessary for performing the above method, depending on the particular embodiment.

The command signal may be directly or indirectly associated to the requested engine power, for example, an accelerator pedal position, a throttle command signal, a value converted or processed therefrom, etc. It is to be understood that depending on the particular device, a command signal may be produced by an actuator such as a pedal, a switch, a joy stick, a button, a lever, a computer user-interface and/or the like. Moreover, it is to be understood that, further to the method described herein, the portion of the vehicle data being associated to the requested engine power may be processed in a number of ways prior to being provided as an input to the method.

The control signal may be a corrected pedal signal sent to the ECM, a corrected throttle command sent to the ETC, or an intermediate signal or value being representative of a limitation of the engine power request, and may further be representative of other limitation(s). As an example wherein the command signal and control-signal limit are proportional to the requested engine power and the engine-power-request limit, respectively, the control signal may correspond to a lesser of the command signal and the control-signal limit. In an embodiment where the command signal is inversely proportional to the requested engine power and the power-request limit is inversely proportional to the engine-power-request limit, the may correspond to a greater of the command signal and the control-signal limit, in order to represent a lesser of the requested engine power and the engine-power-request limit. Moreover, the control signal may be subject to further processing prior to being sent to the engine controller. Indeed, it is to be understood that, further to the method described herein, additional processing of the command signal, control signal, control-signal limit and/or vehicle data may be executed, either prior to the execution of the method, after the execution thereof (as exemplified in FIG. 2) or at an intermediate step, so as to affect the resulting control signal being output to the engine controller, as can be easily understood by a person skilled in the art.

The cumulative-term limit may be variable or constant and may correspond to an upper limit or a lower limit of the cumulative term. The cumulative closed-loop term preferably corresponds to an integral term of a PI controller, however, it may also refer to another cumulative term used in other types of controllers, such as those using fuzzy logic for example, which will be explained further below.

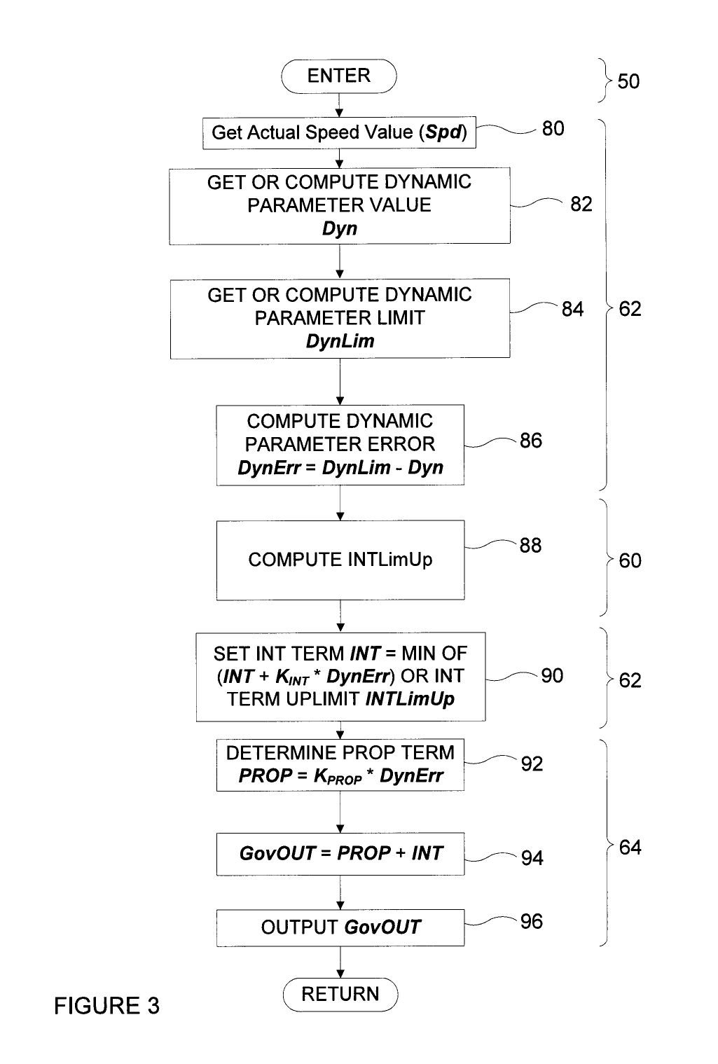

Thus, preferably, the cumulative closed-loop term is an integral closed-loop term INT and the cumulative-term limit is an integral term upper-limit INTLimUp, as better illustrated in FIG. 3. The integral closed-loop term INT is preferably obtained 62 by determining, based on said vehicle data, a current value of the dynamic parameter Dyn 82 of the vehicle, a dynamic-parameter limit DynLim 84 and an error DynErr 86 corresponding to DynLim−Dyn; determining 88 INTLimUp and setting 90 the integral closed-loop term INT to a lesser value of INT+K_{INT}×DynErr and INTLimUp, wherein K_{INT} is an integral gain factor. Moreover, the control-signal limit 96 is preferably based on a sum 94 of a proportional closed-loop term PROP and the integral closed-loop term INT, where PROP is set 92 to K_{PROP}×DynErr, K_{PROP} being a proportional gain factor. K_{INT} and K_{PROP} may vary greatly depending on a number of parameters, for example, based on the particular vehicle, on the range of each signal being provided, the unit of measure of the dynamic parameter, on the particular application (i.e. limiting speed, limiting acceleration, etc.), on the additional processing of the vehicle data, and/or the like, and this, for each embodiment described herein. Preferably the dynamic-parameter limit DynLim 84, also referred to herein as a “target”, corresponds to a threshold which is used to limit the dynamic parameter Dyn 82.

Moreover, it is to be understood that the error DynErr, corresponds essentially to a difference between the limit DynLim and the current value of the dynamic parameter, Dyn and in the case were DynErr is calculated according to Dyn−DynLim, the cumulative-term limit corresponds to a lower limit of the cumulative closed-loop term.

Preferably, the method further comprises: obtaining 80 a speed Spd of the vehicle, based on the vehicle data; and determining 84 the dynamic-parameter limit DynLim as a function of the speed Spd.

### Determining of INTLimUp (Cumulative-Term Upper Limit)

The cumulative-term limit is preferably determined 88 (see FIG. 3), based on at least one of: the command signal, the speed Spd of the vehicle and the control signal, the speed Spd being obtained based on the vehicle data. As previously mentioned, in an integral controller or a PI controller, the cumulative-term limit corresponds to an integral term upper-limit INTLimUp, according to embodiments described herein. An integral term upper-limit may be obtained, for example, as a function of the throttle area, for example, and/or the accelerator pedal position or, optionally, on the accelerator pedal position and the speed of the vehicle.

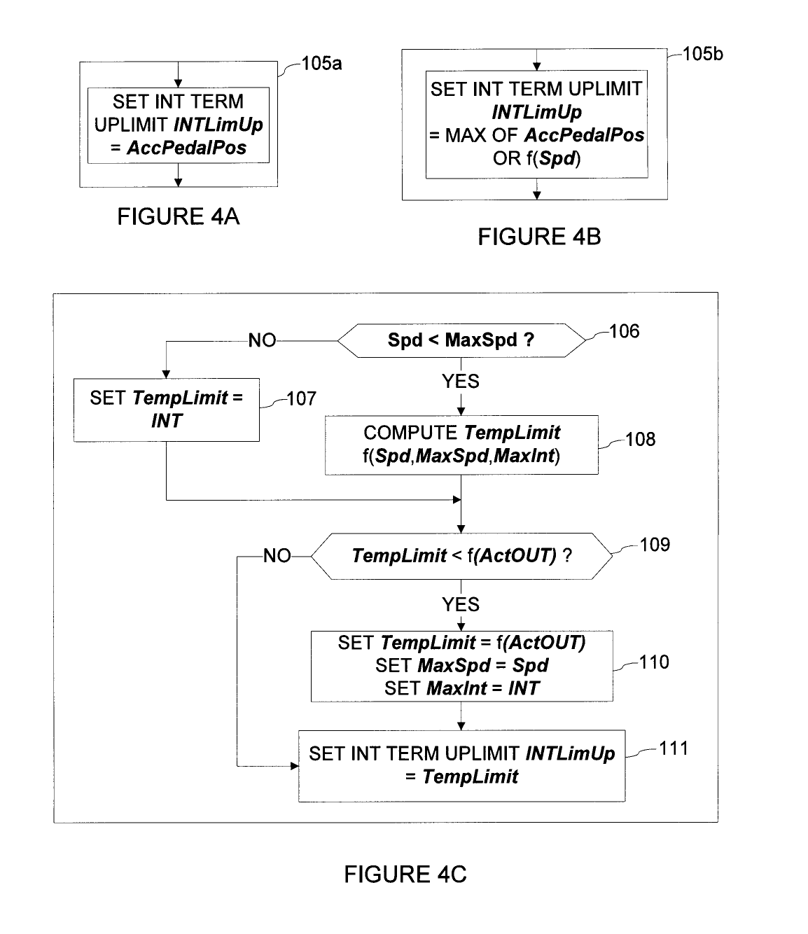

The integral term upper-limit INTLimUp corresponds to an upper bound for the value of the integral term INT. As previously mentioned, the method may or may not limit the acceleration of the vehicle, at any given time. When the dynamic parameter limit is not reached and the dynamic parameter limiting is thus not necessary, the integral term of the PI controller tends to increase excessively. The purpose of the integral term upper-limit INTLimUp is to prevent the integral term INT from increasing excessively in such situations, in order to allow a smoother transition between a non-limiting mode of operation and a limiting mode of operation. This integral term upper-limit INTLimUp also allows to set the integral term at a suitable value whenever the dynamic parameter limit is approached or the accelerator pedal is depressed rapidly beyond the integral term upper-limit INTLimUp. Different alternatives for determining INTLimUp 88, 105, 130 (see FIG. 4A-4C) are exemplified below.

With reference to FIG. 4A, there is shown a first alternative for calculating INTLimUp, referred to herein as “option A”. The command signal corresponds to an accelerator pedal position AccPedalPos, and the integral term upper-limit INTLimUp is set 105a to AccPedalPos. AccPedalPos may range between 0 et 4095, for example. However, it is to be understood that this range and measurement thereof, may vary widely depending on a number of parameters, for example, based on the particular vehicle, on the range of each signal being provided, on the application (i.e. limiting speed, limiting acceleration), on the additional processing of the vehicle data, and/or the like.

With reference to FIG. 4B, there is shown a second alternative for calculating INTLimUp, referred to herein as “option B”. As for option A, the command signal corresponds to an accelerator pedal position AccPedalPos. Furthermore, the speed Spd of the vehicle is obtained based on the vehicle data (step 80 in FIG. 3). The integral term upper-limit INTLimUp is then set 105b to an upper value of AccPedalPos and a value f(Spd) obtained as a function of said speed Spd.

With reference to FIG. 4C, there is shown a third alternative for calculating INTLimUp, referred to herein as “option C”. According to this alternative, the speed Spd of the vehicle is obtained, preferably based on the vehicle data (step 80 in FIG. 3). If the speed Spd is lesser than a maximal speed MaxSpd 106, a temporary limit TempLimit is determined 108 as a function of the speed Spd, the maximal speed MaxSpd and a maximal integral term Max/nt. Otherwise, the temporary limit TempLimit is set 107 to INT. A threshold value f(ActOUT) is then determined as a function of the control signal ActOUT, which is sent to the engine controller, for example an ETC or ECM. According to embodiments of the present invention, ActOUT is representative of either one of the control-signal limit and the command signal, whichever is representative of the lowest engine power request (i.e. a limited command signal) being further limited by other controllers running in the system, as can be understood by a person skilled in the art. Indeed and for example, the limited command signal may be subjected to other processes, which may include a limiting of the speed, for example, and/or the like, as already mentioned.

At step 109, if the temporary limit TempLimit is lesser than the threshold value f(ActOUT), the temporary limit TempLimit is set to f(ActOUT), the maximal speed MaxSpd is set to Spd and the maximal integral term MaxInt is set to INT 110. Then, the integral term upper-limit INTLimUp is set 111 to TempLimit.

It is to be understood that the integral term upper-limit INTLimUp may be calculated in a number of other ways, according to alternative embodiments.

### Limiting the Acceleration of a Vehicle

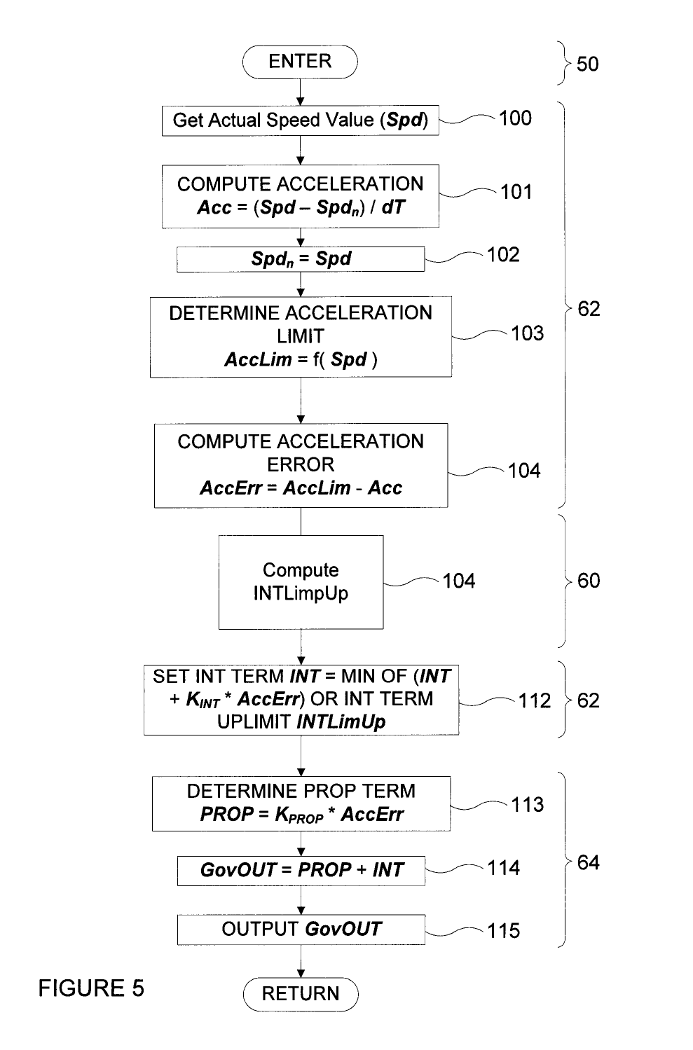

As previously mentioned, the dynamic parameter may be an acceleration. Thus the method would allows limiting the acceleration of a vehicle. In such an embodiment, referring now to FIG. 5, the determining 62 of said integral closed-loop term INT preferably includes: determining, based on the vehicle data, a current acceleration Acc 100, 101, 102 of the vehicle, an acceleration limit of the AccLim 103 and an acceleration error AccErr 104 corresponding to AccLim−Acc; and setting 112 INT to a lesser value of INT+K_{INT}×AccErr and INTLimUp, wherein K_{INT} is an integral gain factor. Still preferably, the control-signal limit GovOUT is calculated 114 based on INT+PROP. Thus, the method preferably includes: setting 113 a proportional closed-loop term PROP to K_{PROP}×AccErr, K_{PROP} being a proportional gain factor; and wherein the determining 115 of the control-signal limit GovOUT is set to a sum of the proportional closed-loop term PROP and the integral closed-loop term INT. K_{INT} may correspond to a value of 0.125, and K_{PROP} may correspond to a value of 0.05, for example, however these values may vary greatly depending on a number of parameters, for example, based on the particular vehicle, on the range of each signal being provided, the unit of measure of the acceleration (example: cm/s², m/s², etc), on the particular application (i.e. limiting speed, limiting acceleration, etc.), on the additional processing of the vehicle data, and/or the like, and this, for each embodiment described herein.

Preferably, the method comprises: obtaining 100 a speed Spd of the vehicle, based on the vehicle data; and determining 103 the acceleration limit AccLim as a function of the speed Spd, alternatively, or as a function of the speed Spd and the speed of the engine.

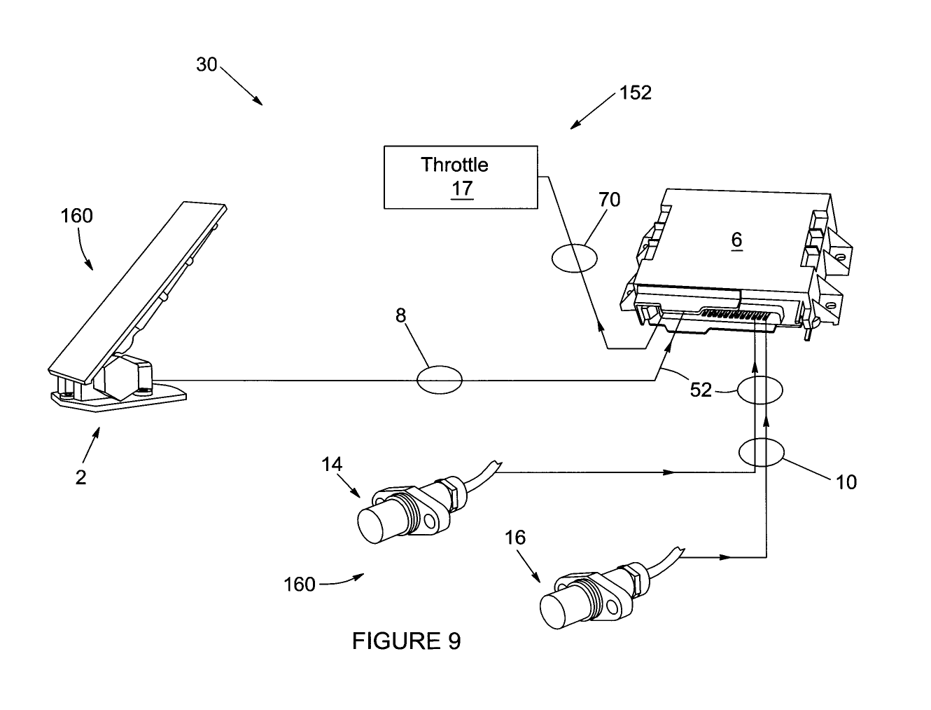

With further reference to FIG. 9, the method is provided, according to this particular embodiment, as data and instructions being embedded within the ECM 6, and the resulting output GovOUT limits the accelerator pedal signal 8 (i.e. the command signal 58). Typically, the ECM further processes this output GovOUT, prior to producing the control signal 70 to be sent to the ETC 17. The present example will now be described with more details.

As previously mentioned, block 100 is executed to read the vehicle speed signal from the stored value in the ECM 6, or from any other speed sensor computation module, thereby defining a vehicle speed term Spd. The vehicle speed information may be obtained from a number of alternate sources in addition to the sensor 14 of FIG. 1. For example, the vehicle speed information may be obtained from ABS wheel speed sensors, or from engine speed and gear; these other sources may be used to confirm or validate the vehicle speed signal obtained from sensor 14, if desired. Successively determined values of Spd (designated in FIG. 5 as Spd and Spdₙ) and delta time dT between them are stored by the ECM 6 for the purpose of computing the vehicle acceleration Acc, as indicated at blocks 101 and 102. In other words, the vehicle acceleration term Acc is computed according to:

$$Acc = \frac{( Spd - {Spd}_{n} )}{dT}$$

Block 103 is then executed to determine a targeted acceleration limit AccLim for the PI controller. The acceleration limit AccLim may be determined based on the vehicle speed Spd or, optionally, on the vehicle speed and engine speed. For example, AccLim may be calculated according to the following equation:

$$AccLim = \frac{( K 1 - K 2 )}{( Speed 1 - Speed 2 )} \times Spd + K 1 ;$$

$$AccLim = - 2.875 \times Spd + 400 ,$$

wherein, constants K1, K2, Speed 1, and Speed2 are used to calculate a slope. In the present example:
K1=400 cm/s²,
K2=55 cm/s²,
Speed1=0 km/h,
Speed2=120 km/h.

It is to be understood that a number of functions and/or calculations may be used in order to determine AccLim depending on the desired result and/or effect, as well as on the particular parameters of the system.

Block 104 then computes an acceleration error AccErr according to the difference between the acceleration limit AccLim and the acceleration term Acc, namely: AccLim−Acc.

As previously mentioned, blocks 105a, 105b and 105c shown in FIGS. 4A, 4B and 4C, respectively, illustrate possible alternatives for determining an integral term upper-limit INTLimUp. As previously mentioned, the method may or may not limit the acceleration of the vehicle, at any given time. When the acceleration limit is not reached and the acceleration limiting is thus not necessary, the integral term of the PI controller tends to increase excessively. The purpose of the integral term upper-limit INTLimUp is to prevent the integral term INT from increasing excessively in such situations, in order to allow a smoother transition from a non-limiting mode of operation and a limiting mode of operation. This integral term upper-limit also allows to set the integral term at a suitable value whenever the acceleration limit is approached or the accelerator pedal is depressed rapidly beyond the integral term upper-limit INTLimUp.

According to option A, block 105a (FIG. 4A) sets the integral term upper-limit INTLimUp to the accelerator pedal position AccPedalPos. This is a simple means of setting the integral term upper-limit and though it is suitable for most situations, it may be unsuitable for some particular circumstances. For example, when a steady speed is achieved and the accelerator pedal is released just before it is depressed again to accelerate, the integral term upper-limit equals zero when the accelerator pedal is released (the pedal position being nul), and thus limits the integral term to zero. As a consequence, the integral term having been brought to nul, is gradually increased, but nevertheless limits the acceleration of the vehicle below AccLim for a certain time interval which may be too long until the acceleration limit is reached or the accelerator pedal is released below the GovOUT (in FIG. 5). This introduces a lag between the time the accelerator pedal is depressed and the time the vehicle starts to accelerate. Block 105b (FIG. 4B) represents an improvement (option B) over the step shown in block 105a. More particularly, the accelerator pedal position AccPedalPos is compared to a computation based on the speed Spd, and the integral term upper-limit INTLimUp is set to the higher of the two values. This method of setting the integral term upper-limit eliminates the lag described above for block 105a, but nevertheless requires the use of empirical values, namely the position of the accelerator pedal at the steady speed, based on speed values stored in a table or derived from an algebraic formula.

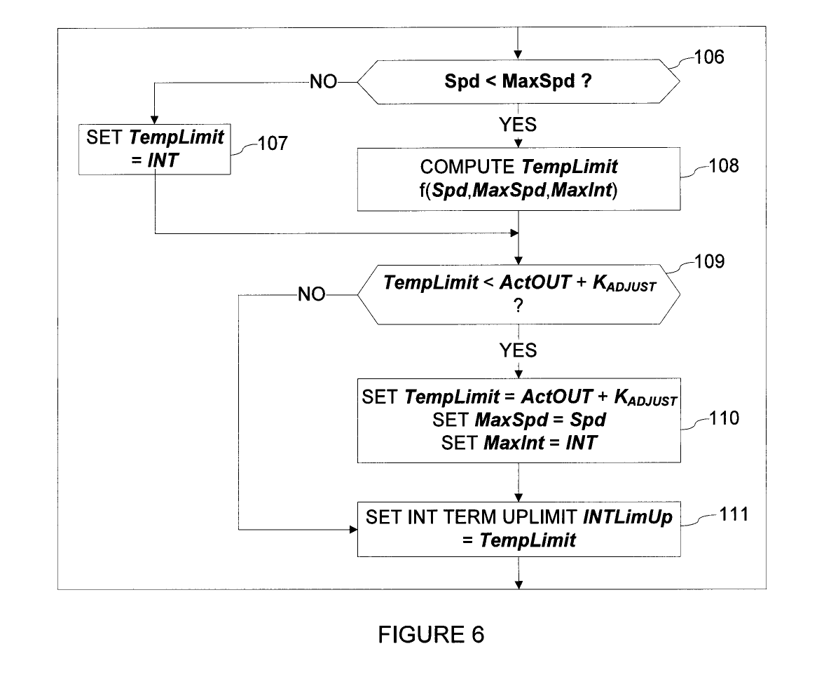

Referring now to FIG. 6, option C (block 105c) for limiting the acceleration of a vehicle is shown. Block 105c represents an improvement over the steps shown in blocks 105b and 105a. Firstly, the current speed Spd and a maximum speed MaxSpd are compared at block 106. If the current speed Spd is not inferior to the maximum speed MaxSpd, then a temporary limit TempLimit is set to a current integral term INT (at block 107), otherwise TempLimit is calculated (at block 108) according to:

Spd/MaxSpd×MaxInt

which is a proportional reduction of the integral term based on reduction of speed, wherein MaxSpd and MaxInt are first initialized at 0 and updated at block 110, as better described further below.

According to another example, TempLimit may be determined based on the following equation:

$$AccIntLimStart = 900$$

$$TempLimit = \frac{( MaxInt - AccIntLimStart )}{( MaxSpd )} \times Spd + AccIntLimStart ,$$

wherein AccIntLimStart is a constant which varies based on the signal range of the accelerator pedal position and the initial position of the accelerator pedal position.

Next, at block 109, the threshold value f(ActOUT) corresponds to a sum of ActOUT and a parameter K_{ADJUST}. Alternatively, f(ActOUT) may correspond to ActOUT only. Alternatively, the threshold value may be the accelerator pedal position AccPedalPos or the sum of AccPedalPos and the parameter K_{ADJUST}. The parameter K_{ADJUST}, though optional, adds responsiveness of the accelerator pedal when the vehicle is accelerating from a nul speed value (i.e. rest). In this particular example, TempLimit is compared at block 109 to ActOUT+K_{ADJUST}. Next, at block 110, if the temporary limit TempLimit is inferior to the threshold value (i.e. ActOUT+K_{ADJUST}), then the temporary limit TempLimit is set to said threshold value. Moreover, the maximum speed MaxSpd is set to the current vehicle speed Spd and the maximal integral term MaxInt is set to the current integral term INT. Otherwise the values of TempLimit, MaxSpd, MaxInt remain unchanged.

This method of determining the integral term upper-limit INTLimUp, as illustrated in block 105c, is compatible to all types of vehicle while reducing the need for empirical values. Moreover, constants being used are applicable to a wider number of vehicles.

At block 112, referring back to FIG. 5, the integral term INT is updated according to the sum (INT+K_{INT}×AccErr), where K_{INT} is the integral gain factor. If the calculated sum is greater than INTLimUp, then INT is replaced by INTLimUp. The proportional term PROP is then determined at block 113 according to the product (K_{PROP}×AccErr). The block 114 is then executed to compute the output of the PI controller, GovOUT according to the sum of the PROP and INT terms.

Block 115 is executed to provide the governed throttle area GovOUT, which represents the control-signal limit, to suitably limit the otherwise requested throttle area. This limited output value (i.e. limited command signal), equal to the lower of a requested throttle area AccPedalPos and the governed throttle area GovOUT, is then typically further processed by the ECM 6 which in turn generates the throttle area ActOUT (i.e. control signal 70, or a portion thereof) to be sent to an engine controller 152, such as ETC 17 (see FIG. 9).

### Limiting the Speed of a Vehicle

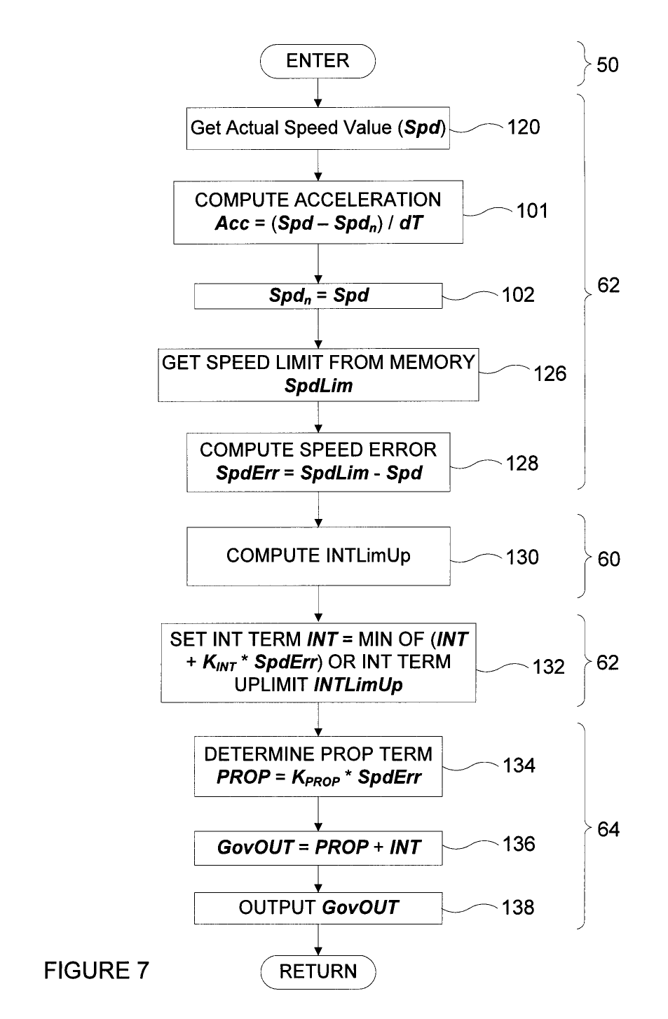

According to yet another embodiment, and as previously mentioned also, the dynamic parameter may be a speed. Thus the method would allow limiting the speed of a vehicle. In such an embodiment, referring now to FIG. 7, the determining 62 of the integral closed-loop term INT preferably includes: determining, based on said vehicle data, a current speed Spd 120 of the vehicle, a speed limit SpdLim 126 of the vehicle and a speed error SpdErr 128 corresponding to SpdLim−Spd; and setting 132 the integral closed-loop term INT to a lesser value of INT+K_{INT}×SpdErr and INTLimUp, K_{INT} being an integral gain factor. Still preferably, the control-signal limit GovOUT is calculated 136 based on INT+PROP. Thus, the method preferably includes: setting 134 a proportional closed-loop term PROP to K_{PROP}×AccErr, K_{PROP} being a proportional gain factor, wherein the control-signal limit is set 138 to a sum of the proportional closed-loop term PROP and the integral closed-loop term INT.

Optionally, steps 101 and 102, may be provided for further determining an acceleration of the vehicle, for example, to combine the present embodiment with the embodiment for limiting the acceleration of the vehicle.

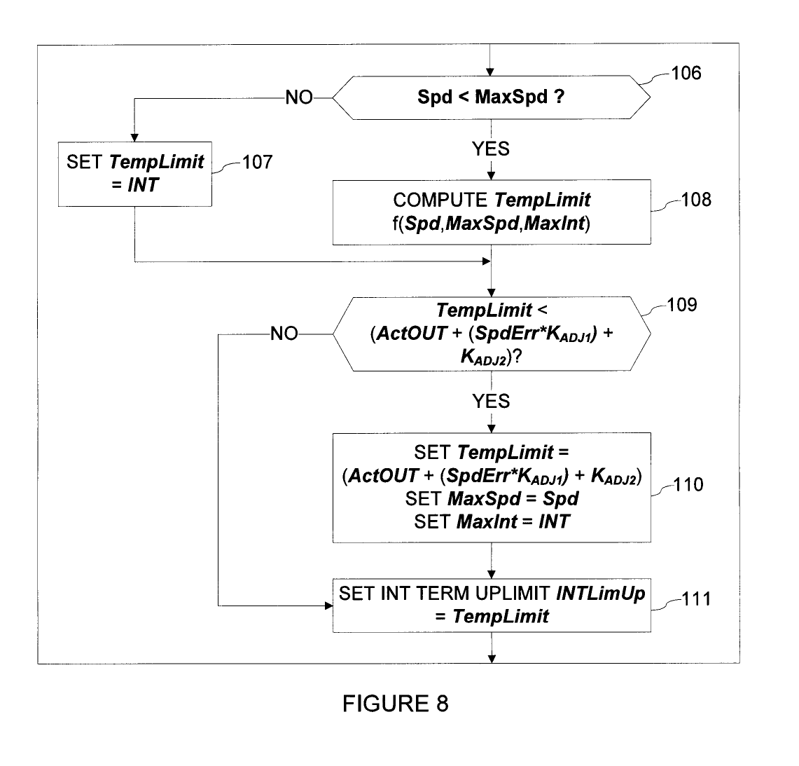

As already explained, the calculation of the integral term upper-limit INTLimUp may be obtained according to options A, B or C, illustrated in FIGS. 4A, 4B and 4C, respectively. An example of option C, for the limiting of a speed of a vehicle, is illustrated with more details in FIG. 8. In this particular embodiment, the threshold corresponds to ActOUT+(SpdErr×K_{ADJ1}) K_{ADJ2}).

For embodiments wherein the method is used to limit the speed of the vehicle, SpdLim may be based on one or more parameter stored in memory, for example a legal speed limit, a geographical location and/or the like. Such parameters may be stored in any suitable memory, data storage element, database, etc, provided on the vehicle (example: ECM, VDCM, etc.) or even externally with respect thereto, as can be easily understood.

Moreover, it is to be understood that the errors, namely AccErr and SpdErr, correspond essentially to a difference between the limit (i.e. AccLim and SpdLim, respectively) and the current value of the dynamic parameter (i.e. Acc and Spd, respectively), and in the case were AccErr is calculated according to Acc−AccLim, or SpdErr is calculated according to Spd−SpdLim, the cumulative-term limit corresponds to a lower limit of the cumulative closed-loop term, as explained above for DynErr.

### Other Aspects of the Method

Preferably, the method includes storing in a memory, at least a portion of the vehicle data and computation data generated by the computation of the vehicle data. The computation data may include any data received or provided by the vehicle, including said vehicle data or portions thereof, as well as data and signal(s) generated during the processing thereof, for example, during an execution of the method described herein. Still preferably, the method includes processing the computation data to extract therefrom output information to be provided to a user via a user interface, such as information related to fuel consumption, for example. Such data may include, current fuel consumption, current acceleration of the vehicle, as well as driver habits, energy and/or amount of fuel having been saved, etc., which may be presented to the driver or to another person, when the computation data is transferred to another device such as a common computer or the like, for monitoring purposes for example.

### Vehicle Dynamics Control Module (VDCM)

According to an embodiment of the present invention, the above-described method is executed by a vehicle dynamics control module (VDCM), such as the previously-described VACM.

Preferably, as better illustrated in FIG. 1, there is provided a system 26 for limiting a dynamic parameter of a vehicle. The system 26 comprises: at least one sensing element 160 for generating vehicle data; a VDCM 11 as described herein for limiting a dynamic parameter of a vehicle, the VDCM 11 being operatively connected to the at least one sensing element 160 for receiving the vehicle data; and an ECM 6 being operatively connected to the VDCM 11 for receiving the control signal 70 therefrom, to limit said dynamic parameter of the vehicle. Thus, according to this particular configuration the ECM 6 is the engine controller 152.

Referring still to FIG. 1, with further reference to FIG. 2, the VDCM 11, limits a dynamic parameter of a vehicle, via the engine controller 152 of the vehicle, the engine controller 152 being operable in response to a control signal 70. The VDCM 11 comprises:
at least one input port 154 for receiving vehicle data 52 from the vehicle, said vehicle data 52 being at least representative of a requested engine power 54;
a module controller 156 being operatively connected to the at least one input port 154, for:
   determining 56, based on said vehicle data 52, a command signal 58 associated to the requested engine power 54;
   determining 60, based on a computation of the vehicle data 52, a cumulative-term limit;
   determining 62, based on a computation of the vehicle data 52, a cumulative closed-loop term, the cumulative closed-loop term being limited according to the cumulative-term limit;
   determining 64 a control-signal limit 66, based on at least the cumulative closed-loop term, the control-signal limit 66 being associated to an engine-power-request limit 55;
   generating the control signal 70 to be sent to the engine controller 152, based on at least a comparison of the command signal 58 and the control-signal limit 66, the control signal being representative of a lesser 68 of the requested engine power 54 and the engine-power-request limit 55; and
at least one output port 158 being operatively connected to the module controller 156, at least one of the at least one output port 158 being in communication with the engine controller 152 for sending thereto the control signal 70 generated by the module controller 156, to limit said dynamic parameter of the vehicle.

The module controller 156 may be any kind of controller located in the VDCM 11 or VACM 1 described herein, being adapted to execute the method of the present invention or a portion thereof. For example, the module controller 156 may be provided by a microcontroller 4 or the like. The module controller 156 preferably comprises a memory 5 for storing at least a portion of the vehicle data and computation data generated by said computation of the vehicle data. The memory 5 may be comprised in the microcontroller 4 or, external and operatively connected thereto, as can be easily understood by a person skilled in the art. The above-described VDCM 11 or VACM 1 may be provided as an add-on component between the acceleration pedal transducer 2 and the ECM 6.

### Engine Control Module—ECM

According to another embodiment of the present invention, the above-described method is provided as part of the code and instructions of an ECM of a vehicle.

Preferably, as better illustrated in FIG. 9, there is provided system 30 for limiting a dynamic parameter of a vehicle. The system 30 comprises: at least one sensing element 160 for generating vehicle data; an ECM 6 as described herein for limiting a dynamic parameter of a vehicle, the ECM 6 being operatively connected to the at least one sensing element 160 for receiving the vehicle data 52; and an engine controller 152, for example an ETC 17 and/or other engine actuator(s), being operatively connected to the ECM 6 for receiving the control signal(s) 70 therefrom, to limit said dynamic parameter of the vehicle. Thus, according to this particular configuration the ETC 17 represents the engine controller 152. It is to be understood however, that a vehicle may include a number of engine controllers, such as additional engine actuators, which may also receive a control signal 70 to cooperate with the ECM 6 and the ETC 17 to control the engine or motor.

Referring still to FIG. 9, with further reference now to FIG. 2, the ECM 6, limits a dynamic parameter of a vehicle, via the engine controller 152 of the vehicle, the engine controller 152 being operable in response to a control signal 70, the ECM 6 comprising data and instructions for execution by a CPU to execute the method described herein.

The term “sensing element” refers to any device including a sensor, a detector, a transducer, a module_(such as an abs module, a GPS receiver, etc.), or the like. Thus, such a sensing element may include an accelerator pedal transducer for generating a pedal-position signal being representative of an accelerator pedal position AccPedalPos, a speed sensor for generating a speed signal being representative of the speed Spd of the vehicle, a GPS receiver for generating a signal being representative of a geographical position of the vehicle, an acceleration sensor for generating an acceleration signal being representative of a current acceleration Acc of the vehicle, and/or the like.

### Other Embodiment

According to an embodiment of the present invention, the method is provided as part of three sub-routines.

According to this embodiment, a first sub-routine calculates and stores an actual acceleration value corresponding to the acceleration of the vehicle and a speed value corresponding to the speed of the vehicle. The speed may be calculated, for a given cycle, by counting the number of pulses received from the vehicle speed sensor signal 10 (FIG. 1) at regular intervals during the cycle. The actual acceleration value may be calculated based on the calculated speed. Indeed, the difference between the calculated speed at the current cycle and the calculated speed at the preceding cycle is divided by the time interval between the two cycles, so as to obtain an actual vehicle acceleration value, which corresponds to the acceleration of the vehicle. Alternatively, the speed and/or acceleration may be received directly from the databus. The acceleration value is then stored in memory. All three values, that is, the speed of the vehicle, the speed of the vehicle at the preceding cycle and the actual acceleration of the vehicle, are updated in memory at every cycle and are accessible by the other sub-routines.

Still according to this particular embodiment, and with reference to FIGS. 1 and 2, a second sub-routine reads the accelerator pedal transducer signal 8, and stores a corresponding actual pedal value (i.e. command signal 58) in memory for later comparison with the control-signal limit 66 (updated by a third sub-routine). If the value of the actual pedal value represents a requested engine power 54 which is greater that the engine-power-request limit 55 associated to the control-signal limit 66, then the control-signal limit 66 is used to determine the control signal 70, namely the output signal 12. Otherwise, the actual pedal value (i.e. command signal 58) is used to determine the output signal (i.e. control signal 70). The third sub-routine updates the control-signal limit 66, based on the method described herein, which is used by the second sub-routine as explained above.

Optionally, the second and third sub-routines may read a bypass switch signal to temporarily deactivate the limiting, if required, for example for security purposes. In a preferred embodiment, this bypass switch is operated by the full throttle switch of the accelerator pedal. Alternatively, the bypass switch may be actuated by any other suitable switching and/or controlling component of a vehicle, and/or by an external device such as a cellular phone, a computer, etc. and/or the like. This feature, when activated, provides the driver with full control of the engine power. According to a preferred embodiment of the present invention, a counting module may also be used to limit the usage of this feature, so as to discourage a driver to overuse the feature. Such a counting module may be easily implemented and customized to the system's owner and/or user(s), as can be easily understood by a person skilled in the art.

### Other Embodiments

According to embodiments of the present invention, a combination of different alternatives of the method may be executed, for example, to limit the acceleration as well as the speed of the vehicle, and/or the like. Furthermore, the method may be executed by a distributed system including the ECM, the VACM and/or any other suitable component of the vehicle.

Thus, the output signal of the PI controller GovOUT may correspond to a modified pedal position value to be processed prior to commanding the motor, or to a throttle command output in order to be fed directly to the ETC and/or other engine or motor actuators. Alternatively, the output signal may correspond to any intermediate value based on a modified pedal position and/or to be processed prior to generating a resulting signal to command the ETC and/or other corresponding motor control component, as can be understood by a person skilled in the art.

According to yet another embodiment, the above described control method is achieved with a fuzzy control system. Such a fuzzy control system is associated to a function having cumulative terms which can also be limited in an analogous manner to the integral term of the PI controller method. If several terms are cumulative, they may be limited as well. Thus, the method described herein, of using a PI controller with an integral upper limit for controlling the acceleration of a vehicle can be obtained in the same manner with a fuzzy control system. Fuzzy logic may use multiple terms such as integral and proportional terms and each cumulative term is preferably limited, for example by an upper limit which is calculated in the same manner as describe above.

Several other modifications may be made to the above-described method, VDCM, ECM and/or system thereof. Indeed and for example, the system may be connected to a communications network so has to be accessible by a remote device for controlling and/or accessing the VDCM or ECM and/or feeding data thereto remotely, for example for identifying a driver. Moreover, an identification system including profiles, vehicle parameters, vehicle location (for example, using a GPS receiver) and driver identity data may be integrated therewith. Furthermore, a data storage module may be provided in the VDCM, ECM and/or system, or operatively connected thereto, according to embodiments of the present invention, for analysis and reporting of vehicle data and/or computation data, or even for transmitting information or instructions thereto. This data, analysis and/or reporting module may be accessible remotely via a telecommunications network using a portable device, a conventional computer, and/or the like as can be easily understood by a person skilled in the art. Moreover, the VDCM or VACM described herein may be combined with a theft of disconnection detection system.

Several other modifications may be made to the above-described method, VDCM, ECM and/or system, without departing from the scope of the present invention. Indeed and for example, a separate circuit may be provided for monitoring the accelerator pedal signals received and output from the VDCM, which may be used to prevent the accelerator pedal output value from differing to greatly with respect to the accelerator pedal input value, in case of a malfunction of the VDCM. Moreover, the VDCM may be further incorporated with a fuel efficiency system including additional features such as an engine turn-off and restart feature. This feature would allow turning off the engine when the driver stops, for example at a delivery point, and restarting the engine prior to driving the vehicle. Moreover, this feature may be integrated with the VDCM via a wireless antitheft device to easily automate the engine turn-off and restart feature. Furthermore, this feature may include an option wherein the engine is turned off when the driver changes transmission from a drive position to a park position, and to restart the engine when the driver presses the brake pedal. Optionally, the automated engine turn-off and restart feature may cooperated with a wireless antitheft device such as included in an RFID system, so as to turn off the vehicle when the RFID system detects that the driver has left the vehicle (i.e. the anti-theft device is out of range) and to restart the engine when the RFID system detects that the driver has returned to the vehicle (the antitheft device is in range). Moreover, the above-described VDCM may include a feature for keeping the heating fan running when the driver stops, for example, at a delivery point, and the engine is turned off by the VDCM.

Moreover, it is also contemplated that embodiments of the present invention are applicable for limiting the speed of a vehicle, for example, by cooperating with a GPS module, to control the speed of the vehicle based on the legal speed limit of the particular road where the vehicle is circulating. Moreover, the VDCM may be integrated in a monitoring system directed to inform and educate a driver based on his or her fuel efficiency driver results.

The VDCM or VACM of the present invention may be integrated in a vehicle at manufacturing, for example as part of the ECM, or may also be distributed as an after-market product on any current vehicle, as well as on most vehicles that are currently in use, as can be easily understood by a person skilled in the art, for example, in the form of a VDCM or VACM as described herein. Moreover, the VDCM, according to a preferred embodiment of the present invention, may be integrated in a conventional ECM, as described herein, or OEM product.

Embodiments of the present invention may be particularly advantageous in that there is provided a system and a method of controlling vehicle dynamics, which preferably reduces fuel consumption, and may be further advantageous for reducing acceleration and speed of a vehicle for security purposes, for example to reduce the risk of an accident when a driver is an apprentice or known to be a fast driver. Indeed, according to embodiments of the present invention, the range of vehicle acceleration which is accessible to a driver by pressing the accelerator pedal may be reduced.

Moreover, embodiments of the present invention may also be advantageous in that the VDCM may be easily integrated in existing vehicles. Moreover, the VDCM preferably varies the acceleration of the vehicle in a stable manner so as to provide a smooth transition and avoid a “back and forth” effect or jerking motion of other systems or possible solutions. Moreover, the VDCM according to embodiments of the present invention recalculates the parameters based on vehicle data so as to better optimize energy consumption. Furthermore, and as briefly explained hereinabove, the control module according to the present invention may be easily integrated and/or combined with a broader vehicle control system.

Furthermore, though the system and method described herein will be particularly useful for trucks, buses and the like, embodiments of the present invention are also intended for other vehicles, as can be understood, such as gasoline or diesel run vehicles, electric vehicles, hybrid vehicles, and/or the like, including cars, mini-vans, motorbikes, scooter, electrically powered bicycles, recreational vehicles, toy vehicles, motorboats, watercrafts and/or any other motorized vehicle, wherein an acceleration control is appropriate. Indeed, the present invention may be of particular use when driving an electric or hybrid vehicle, which may require or at least benefit of such an acceleration limiting feature in order to avoid breakage of equipment for electrical power control, and thus reduce maintenance operation and increase autonomy and to further increase safety of the driver and/or passenger(s), given that electric vehicles are known to accelerate faster than combustion motor vehicles.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A method for limiting a dynamic parameter of a vehicle, via an engine controller of said vehicle, the engine controller being operable in response to a control signal, the method comprising:
a) receiving vehicle data from the vehicle, said vehicle data being at least representative of a requested engine power;
b) determining, based on said vehicle data, a command signal associated to the requested engine power;
c) determining, based on a computation of the vehicle data, a cumulative-term limit;
d) determining a cumulative closed-loop term, based on a computation of the vehicle data, the cumulative closed-loop term being limited according to the cumulative-term limit;
e) determining a control-signal limit, based on at least the cumulative closed-loop term, the control-signal limit being associated to an engine-power-request limit; and
f) generating the control signal to be sent to the engine controller, based on at least a comparison of the command signal and the control-signal limit, the control signal being representative of a lesser of the requested engine power and the engine-power-request limit, for limiting said dynamic parameter of the vehicle.

2. The method according to claim 1, wherein the cumulative closed-loop term is an integral closed-loop term INT and the cumulative-term limit is an integral term upper-limit INTLimUp, wherein the determining of said integral closed-loop term INT of step (d) comprises:
determining, based on said vehicle data, a current value of the dynamic parameter Dyn of the vehicle, a dynamic-parameter limit DynLim and an error DynErr corresponding to DynLim−Dyn; and
setting the integral closed-loop term INT to a lesser value of INT+K_{INT}×DynErr and INTLimUp,
wherein K_{INT} is an integral gain factor.

3. (canceled)

4. The method according to claim 2, further comprising:
setting a proportional closed-loop term PROP to K_{PROP}×DynErr,
wherein K_{PROP} is a proportional gain factor; and
wherein the determining of the control-signal limit of step (e) is based on a sum of the proportional closed-loop term PROP and the integral closed-loop term INT.

5. The method according to claim 2, further comprising:
obtaining, based on the vehicle data, a speed Spd of the vehicle; and
wherein the dynamic-parameter limit DynLim is determined as a function of said speed Spd.

6. (canceled)

7. The method according to claim 2, wherein the dynamic parameter is an acceleration, and wherein the determining of said integral closed-loop term INT of step (d) comprises:
determining, based on said vehicle data, a current acceleration Acc of the vehicle, an acceleration limit AccLim and an acceleration error AccErr corresponding to AccLim−Acc; and
setting the integral closed-loop term INT to a lesser value of INT+K_{INT}×AccErr and INTLimUp,
wherein K_{INT} is an integral gain factor.

8. (canceled)

9. The method according to claim 7, further comprising:
setting a proportional closed-loop term PROP to K_{PROP}×AccErr,
wherein K_{PROP} is a proportional gain factor; and
wherein the determining of the control-signal limit of step (e) is based on a sum of the proportional closed-loop term PROP and the integral closed-loop term INT.

10. The method according to claim 7, further comprising:
obtaining, based on the vehicle data, a speed Spd of the vehicle; and
wherein the acceleration limit AccLim is determined as a function of said speed Spd.

11. (canceled)

12. The method according to claim 2, wherein the dynamic parameter is a speed, and wherein the determining of said integral closed-loop term INT of step (d) comprises:
determining, based on said vehicle data, a current speed Spd of the vehicle, a speed limit SpdLim and a speed error SpdErr corresponding to SpdLim−Spd; and
setting the integral closed-loop term INT to a lesser value of INT+K_{INT}×SpdErr and INTLimUp,
wherein K_{INT} is an integral gain factor.

13. (canceled)

14. The method according to claim 12, further comprising:
setting a proportional closed-loop term PROP to K_{PROP}×SpdErr,
wherein K_{PROP} is a proportional gain factor; and
wherein the determining of the control-signal limit of step (e) is based on a sum of the proportional closed-loop term PROP and the integral closed-loop term INT.

15. (canceled)

16. (canceled)

17. The method according to claim 1, further comprising:
obtaining, based on the vehicle data, a speed Spd of the vehicle; and
wherein the determining of the cumulative-term limit of step (c) is based on at least one of: said command signal, said speed Spd of the vehicle and said control signal.

18. The method according to claim 2 wherein the command signal corresponds to an accelerator pedal position AccPedalPos, and wherein the determining of said integral term upper-limit INTLimUp of step (c) comprises:
setting the integral term upper-limit INTLimUp to AccPedalPos.

19. The method according to claim 2 wherein the command signal corresponds to an accelerator pedal position AccPedalPos, and wherein the determining of said the integral term upper-limit INTLimUp of step (c) comprises:
obtaining, based on the vehicle data, a speed Spd of the vehicle; and
setting the integral term upper-limit INTLimUp to an upper value of AccPedalPos and a value f(Spd) obtained as a function of said speed Spd.

20. The method according to claim 2 wherein the determining of said the integral term upper-limit INTLimUp of step (c) comprises:
obtaining, based on the vehicle data, a speed Spd of the vehicle;
if said speed Spd is lesser than a maximal speed MaxSpd, determining a temporary limit TempLimit as a function of the speed Spd, the maximal speed MaxSpd and a maximal integral term MaxInt; and
otherwise, setting the temporary limit TempLimit to INT;
determining a threshold value as a function of the control signal; and
if the temporary limit TempLimit is lesser than the threshold value, setting the temporary limit TempLimit to said threshold value, setting the maximal speed MaxSpd to Spd and setting the maximal integral term MaxInt to INT; and
setting the integral term upper-limit INTLimUp to TempLimit.

21. (canceled)

22. (canceled)

23. A VDCM for limiting a dynamic parameter of a vehicle, via an engine controller of said vehicle, the engine controller being operable in response to a control signal, the VDCM comprising:
at least one input port for receiving vehicle data from the vehicle, said vehicle data being at least representative of a requested engine power;
a module controller being operatively connected to the at least one input port, for:
determining, based on said vehicle data, a command signal associated to the requested engine power;
determining, based on a computation of the vehicle data, a cumulative-term limit;
determining a cumulative closed-loop term, based on a computation of the vehicle data, the cumulative closed-loop term being limited according to the cumulative-term limit;
determining a control-signal limit, based on at least the cumulative closed-loop term, the control-signal limit being associated to an engine-power-request limit; and
generating the control signal to be sent to the engine controller, based on at least a comparison of the command signal and the control-signal limit, the control signal being representative of a lesser of the requested engine power and the engine-power-request limit; and
at least one output port being operatively connected to the module controller, at least one of the at least one output port being in communication with the engine controller for sending thereto the control signal generated by the module controller, to limit said dynamic parameter of the vehicle.

24. (canceled)

25. (canceled)

26. An ECM for limiting a dynamic parameter of a vehicle, via an engine controller of said vehicle, the engine controller being operable in response to a control signal, the ECM comprising data and instructions to:
receive vehicle data from the vehicle, said vehicle data being at least representative of a requested engine power;
determine, based on said vehicle data, a command signal associated to the requested engine power;
determine, based on a computation of the vehicle data, a cumulative-term limit;
determine a cumulative closed-loop term, based on a computation of the vehicle data, the cumulative closed-loop term being limited according to the cumulative-term limit;
determine a control-signal limit, based on at least the cumulative closed-loop term, the control-signal limit being associated to an engine-power-request limit; and
generate the control signal to be sent to the engine controller, based on at least a comparison of the command signal and the control-signal limit, the control signal being representative of a lesser of the requested engine power and the engine-power-request limit, for limiting said dynamic parameter of the vehicle.

27. A system for limiting a dynamic parameter of a vehicle, the system comprising:
at least one sensing element for generating vehicle data;
a VDCM according to claim 23, the VDCM being operatively connected to the at least one sensing element for receiving the vehicle data; and
an ECM being operatively connected to the VDCM for receiving the control signal therefrom, to limit said dynamic parameter of the vehicle.

28. A system for limiting a dynamic parameter of a vehicle, the system comprising:
at least one sensing element for generating vehicle data;
an ECM according to claim 26, the ECM being operatively connected to the at least one sensing element for receiving the vehicle data; and
one or more engine actuator being operatively connected to the ECM for receiving the control signal therefrom, to limit said dynamic parameter of the vehicle.

29. (canceled)

30. (canceled)

31. (canceled)

32. (canceled)

33. A vehicle comprising a VDCM, according to claim 23.

34. A vehicle comprising an ECM, according to claim 26.

35. A vehicle comprising a system according to claim 27.

36. A computer product comprising data and instructions to limit a dynamic parameter of a vehicle via an engine controller being operable in response to a control signal, for execution by a CPU to:
receive vehicle data from a vehicle, said vehicle data being at least representative of a requested engine power;
determine, based on said vehicle data, a command signal associated to the requested engine power;
determine, based on a computation of the vehicle data, a cumulative-term limit;
determine a cumulative closed-loop term, based on a computation of the vehicle data, the cumulative closed-loop term being limited according to the cumulative-term limit;
determine a control-signal limit, based on at least the cumulative closed-loop term, the control-signal limit being associated to an engine-power-request limit; and
generate the control signal to be sent to the engine controller, based on at least a comparison of the command signal and the control-signal limit, the control signal being representative of a lesser of the requested engine power and the engine-power-request limit, for limiting said dynamic parameter of the vehicle.

37. A vehicle comprising a system according to claim 28.
